(19) United States
(12) Patent Application Publication
(10) Pub. No.: US 2014/0131135 A1
(43) Pub. Date: May 15, 2014

(54) Acoustic Enhancement Balancer

(71) Applicant: Jamell Lamar Hinson, Smyrna, DE (US)

(72) Inventor: Jamell Lamar Hinson, Smyrna, DE (US)

(21) Appl. No.: 13/675,793

(22) Filed: Nov. 13, 2012

(51) Int. Cl. G10K 11/16

(52) U.S. Cl. CPC G10K 11/16
USPC 181/284

(57) ABSTRACT

An audio recording apparatus that improves atmospheric acoustic conditions by method of processing sound forms presented directly or non directly to either the front or rear of the device. Presented sound forms pass through an internal structure comprised of a series of inlaid acoustic panels, sound dampeners, audio baffles, sound chambers, and noise cancellation filters to result in a more purified balanced sound that is ideal to be recorded into a microphone. This audio purification system is a 180 degree or 360 degree audio filtering system with attached frontal sound filter and top mounted acoustic panel. The device is capable of supporting 360 degree sound filtration with a frontal acoustic filter attachment and overhead acoustic control with a top mounted acoustic ceiling panel.

### CROSS REFERENCE TO RELATED APPLICATIONS

Provisional patent application: 61/629,104

### FIELD OF THE INVENTION

The invention relates to a method of improved acoustic sound control in environments that may or may not be treated to provide ideal acoustic atmospheric conditions for audio recording.

### BACKGROUND OF THE INVENTION

Audio recording depends heavily on audio acoustics to provide ideal atmospheric conditions. Ideal acoustic conditions allow vocal artists, instruments, or effects to be cleanly and clearly recorded without external interference. Music studios are ideally purpose built facilities that are designed for capturing audio properly. Over the years as music recording technology has advanced, general access to recording instrumentation has allowed artists and recording enthusiast to be able to create audio recordings in non studio or acoustically treated locations. These locations can be anywhere they are able to setup a microphone and recording device. More often enough it is in a location that is not acoustically treated or purpose built for capturing audio. The end result is that recordings that are created in these locations often end up sounding inferior due to external noise interference and room condition interference such as ambiance, echo, and vocal bouncing etc.

These non studio recordings often require strenuous post audio cleanup that is usually performed through audio recording software. Although some software is able to improve these recordings, they are never able to truly bring out an audio recording to the level of a recording that has been created in a controlled acoustic environment such as a studio. This is a problem that has been increasing greatly as more and more audio recording is being done outside the studio. Some alternatives to improve non studio recording may include attempts at using acoustic foam tiles to treat troublesome room areas or using devices like reflection filters or sound isolators in attempts to mimic a more controlled environment.

The issue that arises with some of these solutions is that room conditions are usually still present and minimally reduced. These types of devices focus mainly on modulating sounds being implemented directly in front of a microphone and do little against actual acoustic conditions of the room itself. Essentially these devices are incapable of “Internal” (sound presented directly in front of these devices, and “External” (sounds presented to the rear of these devices) acoustic noise filtration. They are only designed to manipulate sound that is presented to them in one direction (Internal sound).

Acoustic tiling is often the best method of improving room acoustics; however, the problem with acoustic tiling is that it is a permanent solution and not ideal for locations where users may use their home or non studio recording areas for dual purposes. If a recording enthusiast has made their kitchen or living room their desired recording location, it may not be a feasible solution for them to place acoustic tiling in their living areas as it does not pertain to day to day usage.

To meet the needs of non studio recording it would require an acoustic device that is capable of handling sounds presented directly into a microphone, as well as external atmospheric acoustic conditions. This device should also not be limited to being removed or stored for day to day living convenience if not needed.

### BRIEF SUMMARY OF THE INVENTION

The Acoustic Enhancement Balancer provides acoustic audio sound control in recording environments that may or may not include acoustic room treatments. The device functions by processing sound forms presented to either the front or rear of the unit through an internal sound filtration system. This system allows the device to handle atmospheric acoustic room conditions as well as sounds implemented directly into the system for intended audio recording. Sound forms in the likeness of a voice, instrument, or sound effects pass through a series of inlaid acoustic panels, sound dampeners, audio baffles, and noise cancellation filters. As sound enters the unit, sound forms move through this system of acoustic materials to create a clean and balanced sound that is ideal for audio recording. The Acoustic Enhancement Balancer can also be used with or without a microphone stand and does not require a permanent installation so it can be easily removed or stored for convenience.

### BRIEF DESCRIPTION OF THE SEVERAL VIEWS OF THE DRAWINGS

FIG. 1 Shows a diagram of the removable and adjustable acoustic sound panel attached to the top of the Acoustic Enhancement Balancer.

FIG. 1-a Displays a semi-diagrammatic view of the front of the Acoustic Enhancement balancer. Acoustic ceiling panel is also shown in place on the unit.

FIG. 2 Shows a frontal diagram of the installed front mounted acoustic microphone filter attached to the front of the acoustic enhancement balancer. This filter allows for 360 degree sound filtration coverage.

FIG. 2-a Displays an inverted view of the Acoustic Enhancement Balancer. In this position the unit is capable of having a microphone installed in a hanging position, or for the unit itself to be installed in a hanging position from a microphone boom arm.

FIG. 3 Shows a side diagrammatic view of the Acoustic Enhancement Balancer with units installed front microphone filter attachment that allows 360 degree acoustic coverage.

FIG. 3-a Shows a rear diagram of the Acoustic Enhancement Balancer with the top mounted acoustic support panel installed. This diagram illustrates the adjusting system to raise and lower the acoustic ceiling panel. The Acoustic Enhancement balancers rear so

FIG. 4 Shows a frontal diagram of the acoustic foam layout. The front of the Acoustic Enhancement Balancer also features sound traps to capture in projected sound waves.

FIG. 4-a Displays an additional view of the front of the Acoustic Enhancement Balancer. In this illustration a microphone is installed at the front of the unit.

FIG. 5 Sectional view displaying internal components of the acoustic filtration system.

FIG. 5-a Sectional view of the Acoustic Enhancement Balancer with sound wave filters installed over the sound plate chambers illustrated in FIG. 5.

FIG. 6 Displays a rear diagram view of the Acoustic Enhancement Balancer. In this illustration the external features of the system are displayed.

FIG. 6-a Illustrates is a rear view of an Acoustic Enhancement Balancer installed onto a microphone stand.

FIG. 7 Front view diagram of the Acoustic Enhancement Balancer displaying various acoustic components.

FIG. 7-a Rear view diagram of the Acoustic Enhancement Balancer displaying the rear sound deflector and mounting components.

FIG. 8 External layer rear Mesh filtration screen elevational view. Illustrated in FIG. 5-5-a component B9

FIG. 8-a Internal layer Acoustic fiber material base layer elevational view. Illustrated in FIG. 5-5-a component B9

FIG. 9 Sectional view of the second sound contact filtering layer located underneath the acoustic foam contact layer.

FIG. 10 Diagram of the Acoustic Enhancement Balancer shown in an inverted overhead mounting position.

FIG. 11 Alternative diagrammatic view of the Acoustic Enhancement balancer in an inverted overhead mounting position.

### DETAILED DESCRIPTION OF THE INVENTION

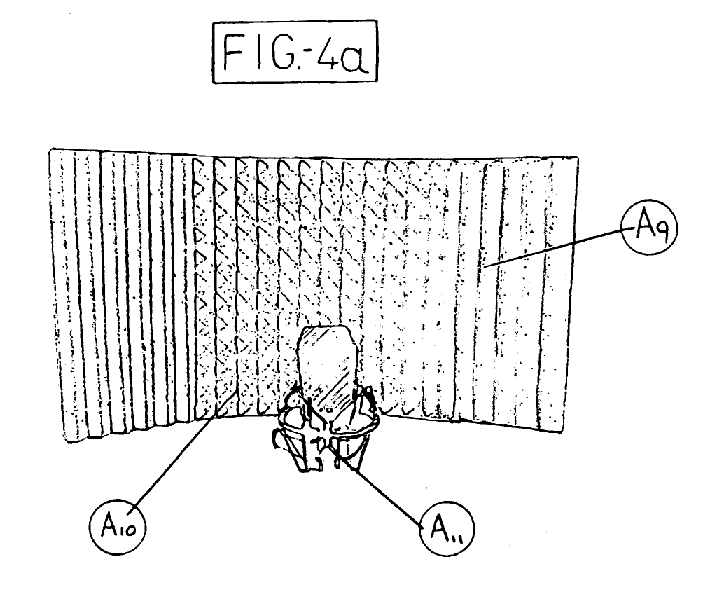

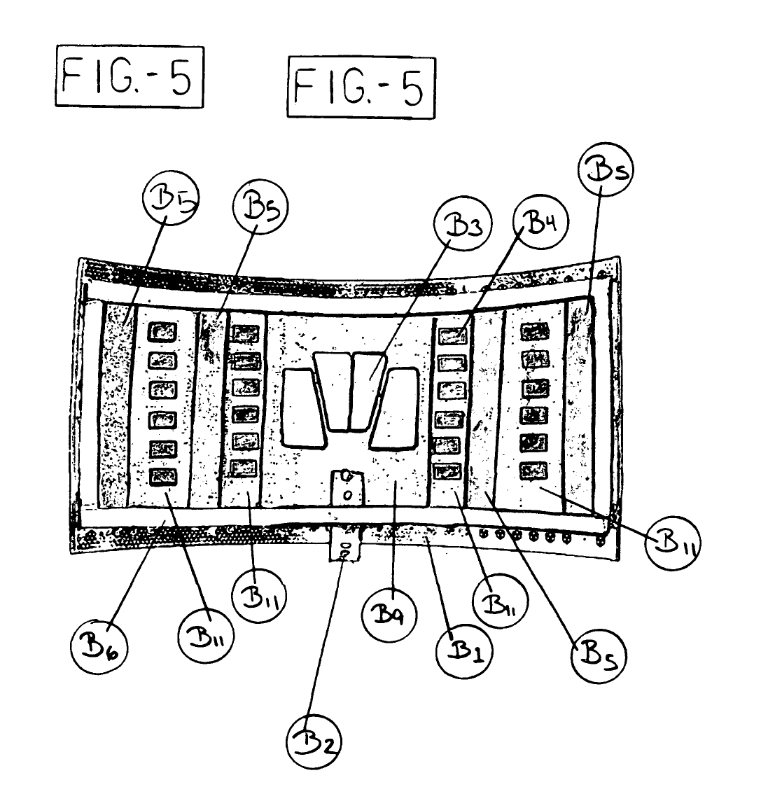

The Acoustic Enhancement Balancer functions by processing sound forms presented to the unit in the likeness of a voice, instrument, or sound effects capture through a series of inlaid acoustic panels, sound dampeners, audio baffles, and noise cancellation filters shown in diagram in FIG. 5-5a. As sound enters the unit, audio wave forms pass through this system of acoustic materials to create a clean and balanced sound that is then further captured into a microphone input for recording.

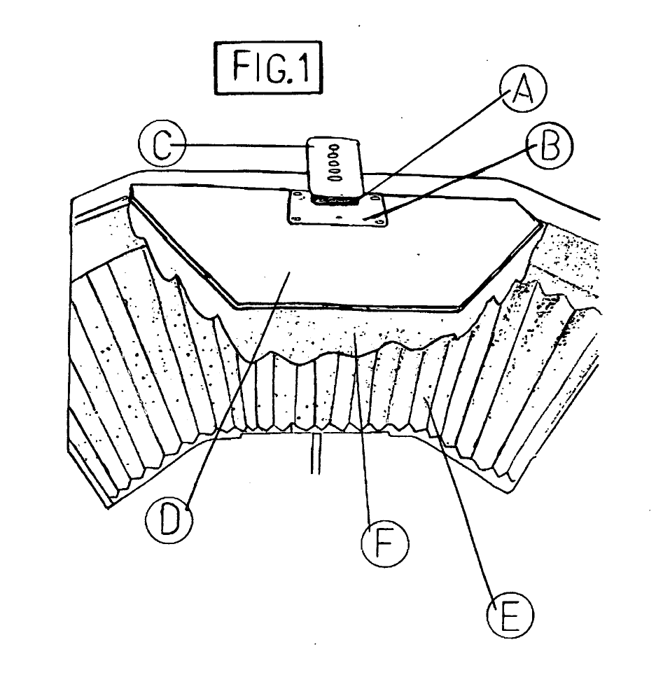

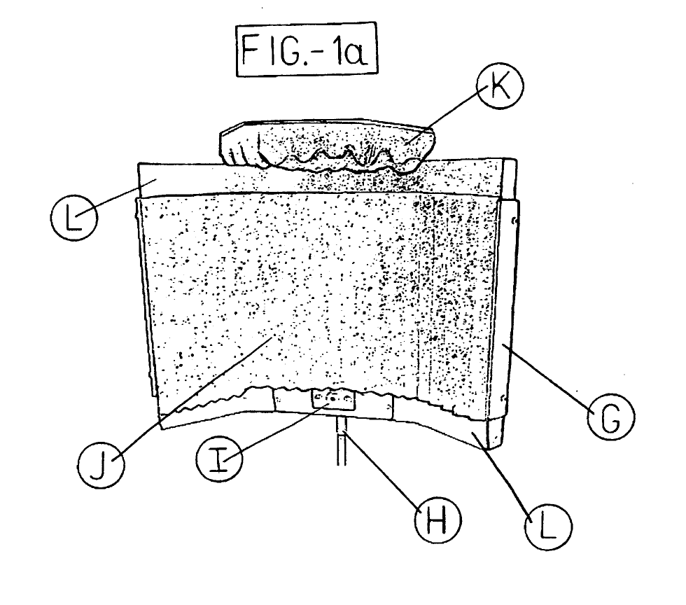

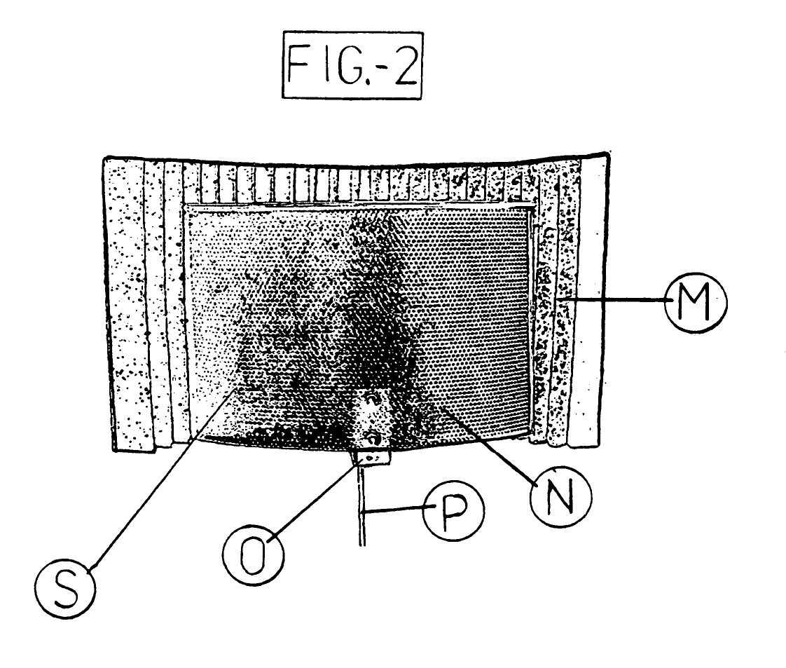

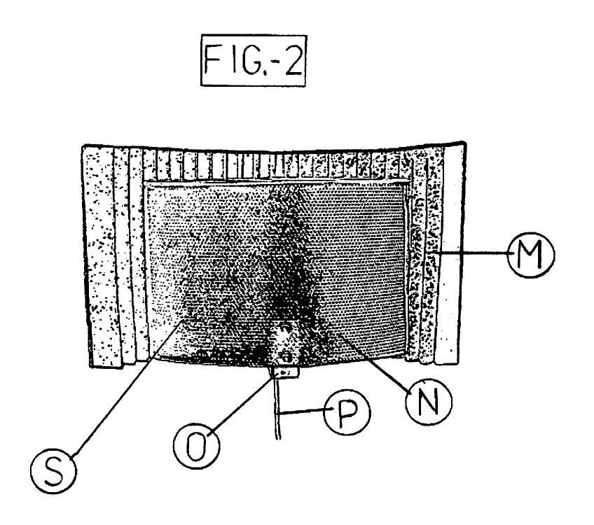

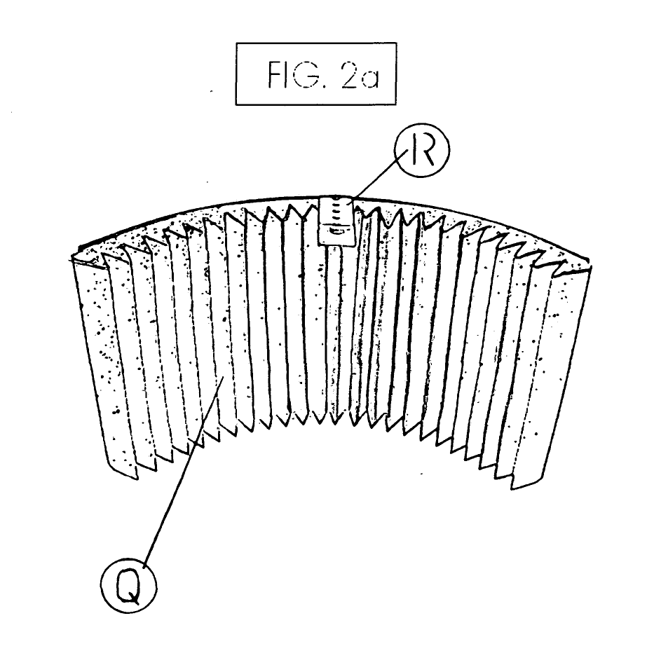

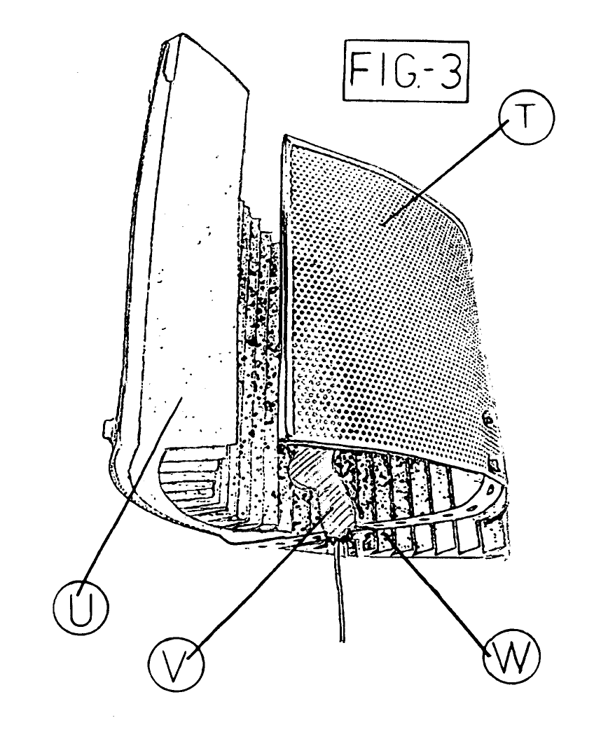

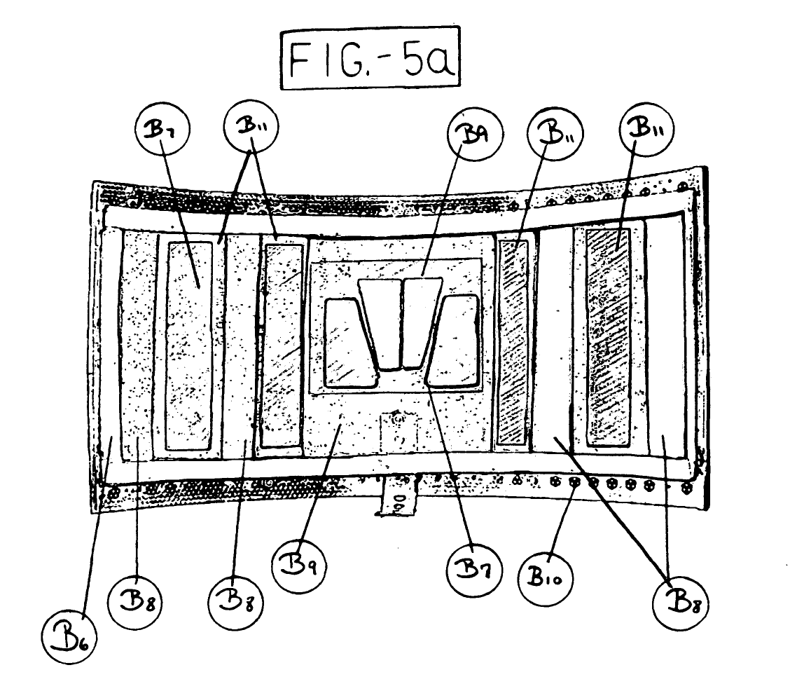

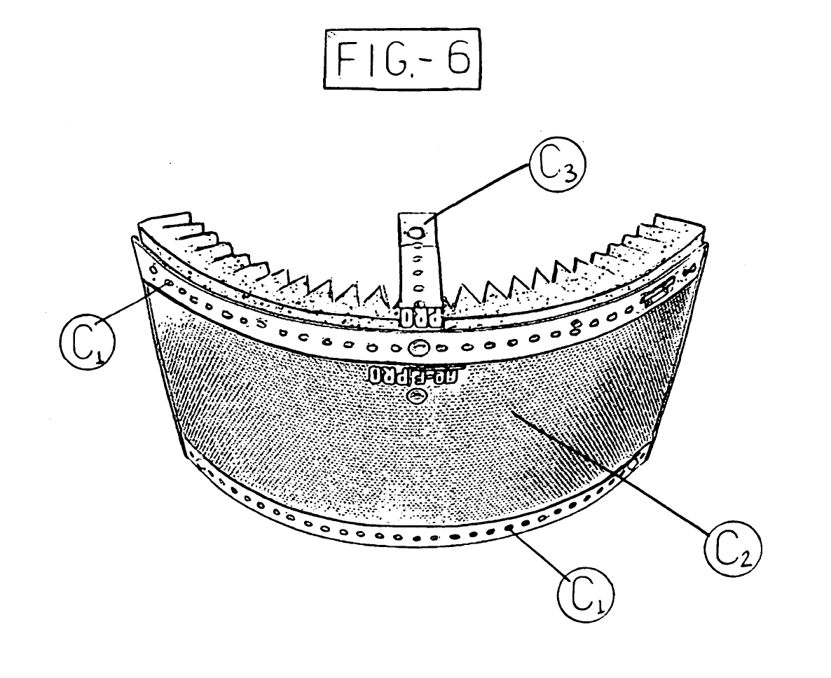

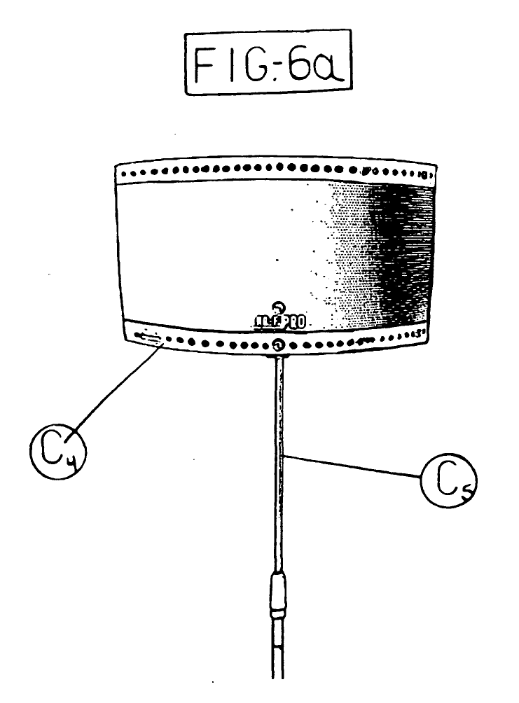

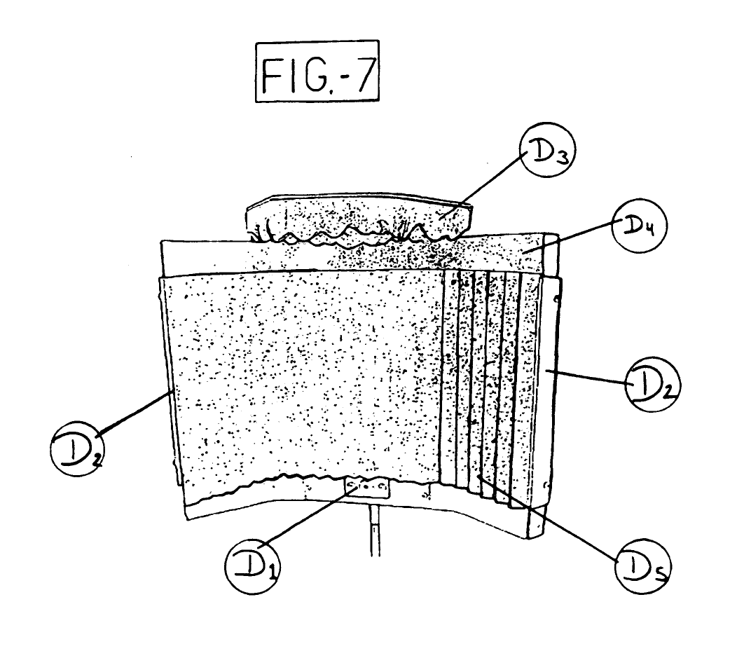

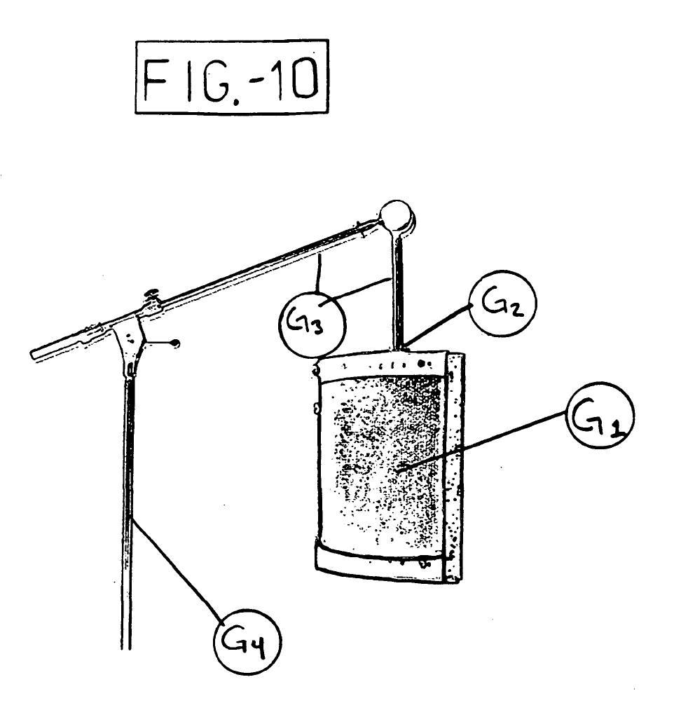

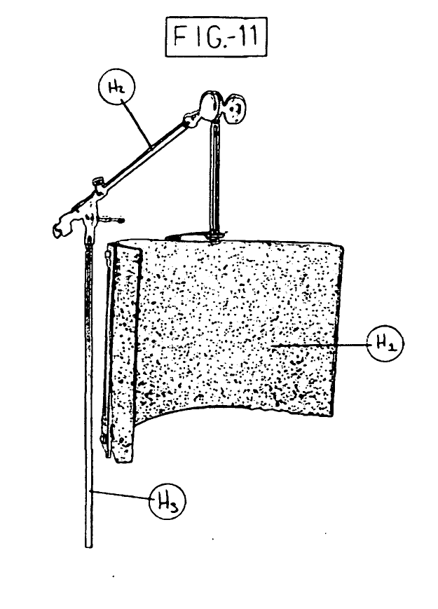

This audio purification system is a 180 degree or 360 degree audio filtering system with attached frontal sound filter shown in FIG. 2 component (N), FIG. 3 component (T) and top mounted acoustic panel displayed in FIG. 1 component (D), FIG. 1-a component (K), and FIG. 3-a component (X). The unit can be mounted directly to a microphone stand as shown in FIG. 1-a component (H), FIG. 2 component (O)-(P), FIG. 2-a component (R). FIG. 6 component (C3) FIG. 6-a component (C5), or boom microphone extension utilizing an adjustable mount that allows free motion and alternative positioning of the acoustic enhancement balancer FIG. 1-a component (I), mounting examples illustrated in FIG. 10, and FIG. 11. Additional features and attachments include a top mounted acoustic panel that can be removed via, magnetic or locking mechanism illustrated in FIG. 1-a components (A)-(B), or adjusted for height instantly via, a quick release mount shown in FIG. 1 component (D),(C), FIG. 1-a component (K), FIG. 3-a component (X),(Y),(Z),(A4), FIG. 7 component (D3) and FIG. 7-a component (D8), allowing the top panel to be removed completely from the system if not needed. An additional Front mounted filter can also be applied to the front of the unit to provide 360 degree acoustic sound support as shown in FIG. 2 component (N),(S) and FIG. 3 component (T).

The body frame design of the Acoustic Enhancement Balancer is curved, bowed, or semi hexagonally shaped to allow for sound to be distributed evenly across the filtration system as shown in FIG. 1-a, FIG. 2-a, FIG. 6, and FIG. 7-7a. This design is non restrictive to air flow and allows the purification system to filter both noise directly presented to the front of the sound filtering system, as well as indirect sounds presented to the rear of the filtering system. This setup allows the Acoustic Enhancement Balancer to function as a 2-way sound purification system.

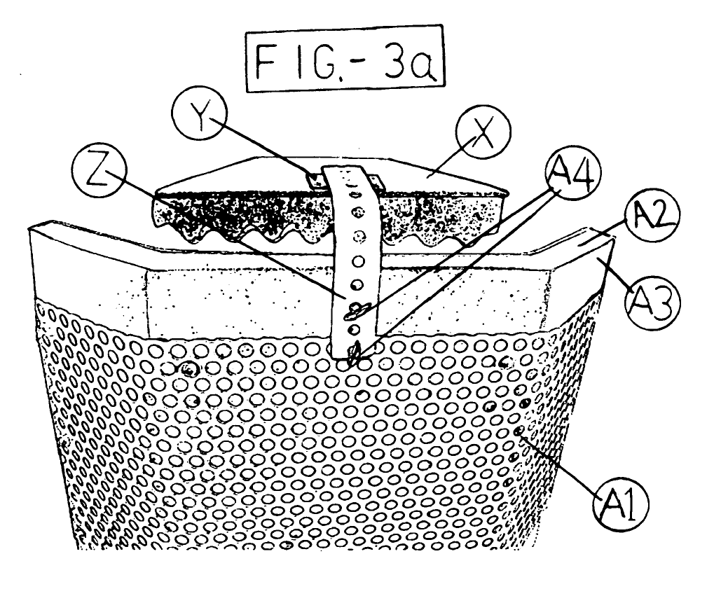

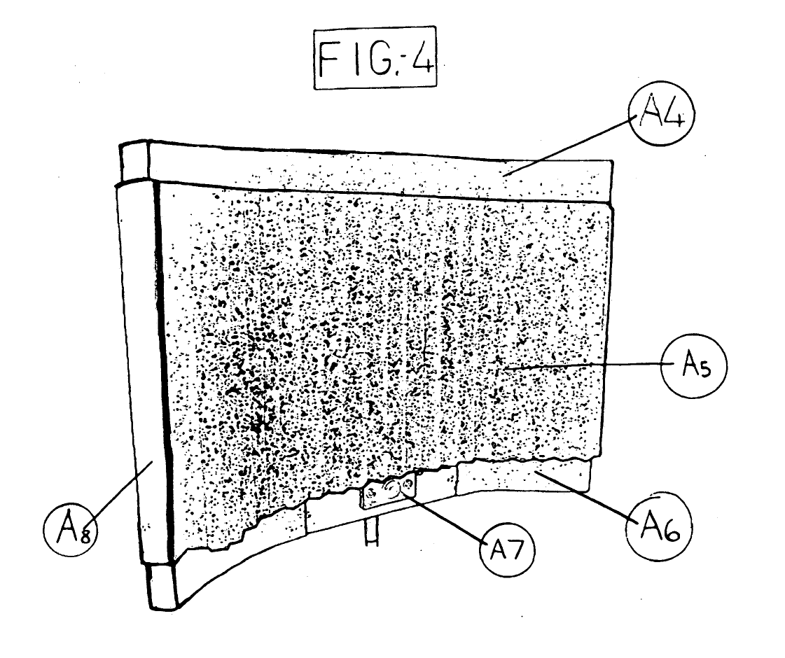

The Acoustic Enhancement Balancer system is first presented with a sound contact layer of acoustic foam. This contact layer of acoustic foam is placed on the front of the unit where sound is intended to be projected into a microphone. This foam layer may be ribbed, pyramid, smooth, flat, or rounded in style illustrated in FIG. 1 component (E), FIG. 1-a component (J), FIG. 2-a component (Q), FIG. 4 component (A5) FIG. 4-a component (A9)-(A10). The acoustic foam layer adds to support sound capturing in reducing audio ambience and sound distortion. This layer can also be supported by additional sound dampening catches located on the upper and lower portions of the Acoustic Enhancement Balancer as shown in FIG. 1-a component (L) and to the left and right ends of the body frame as shown in FIG. 1-a component (G), FIG. 4 component (A8), FIG. 7 component (D2).

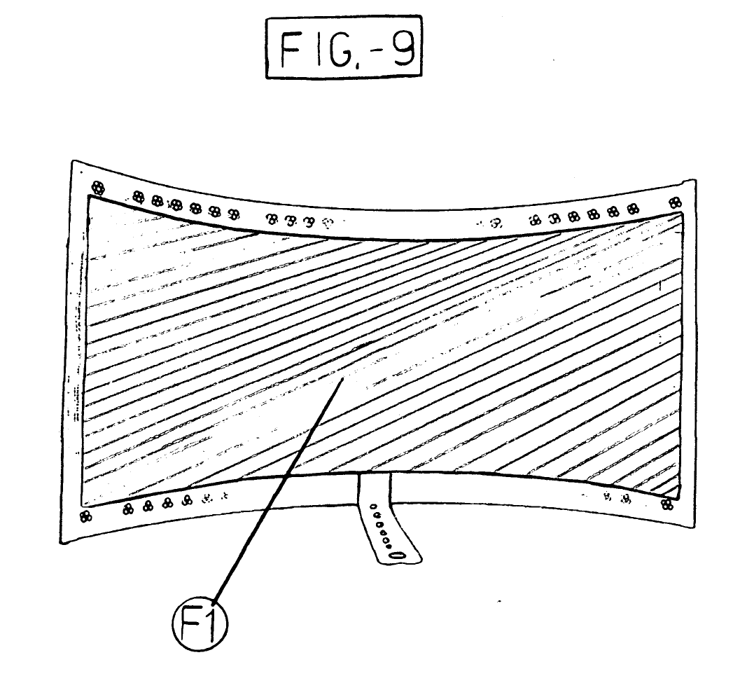

When sound passes through the acoustic foam contact layer it is further met by the second sound contact filtering layer which includes a foam screen filter shown in FIG. 9 component (F1) which assists in the further reduction of audio reflections and sound distortion. This second foam filtering layer additionally acts as a protective shroud for the sound balancing purification chamber system behind it.

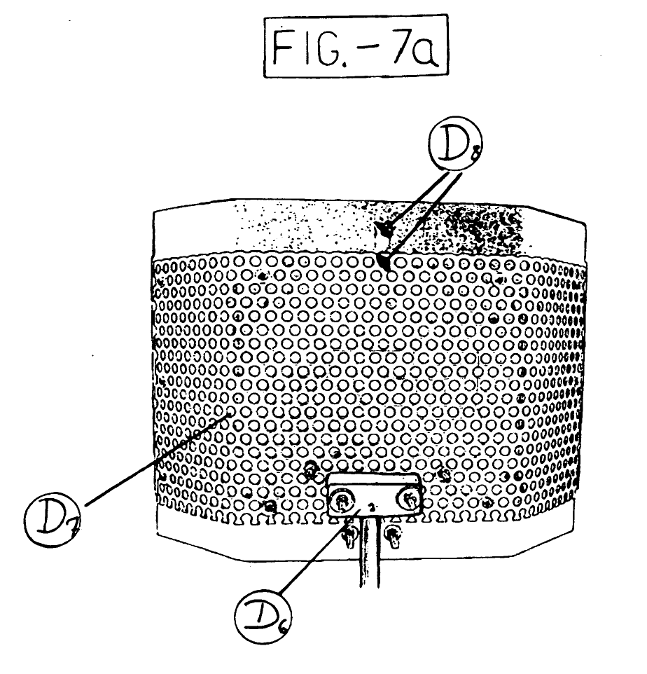

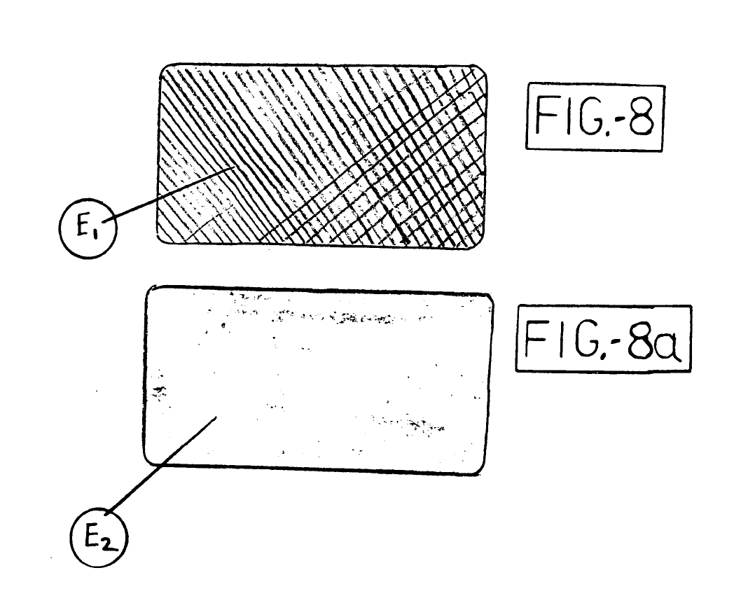

The Rear of the Acoustic Enhancement Balancer features a contact layer designed for filtering external sound conditions presented to the unit as illustrated in FIG. 8-8a. The external contact layer is comprised of a 2 piece system that features a meshed filtration screen FIG. 8 component (E1), and an acoustic fiber material layer attached to the rear of it facing the internal/microphone side of the Acoustic Enhancement Balancer FIG. 8-a component (E2). This layer is located behind the units rear frame/guard and makes up the body portion of the filter. This guard can be perforated or meshed and is designed to be an open system to allow air flow/sound to enter or exit the internal acoustic sound chambering system as shown in FIG. 3-a component (A1), FIG. 6 component (C2), FIG. 7-a component (D7). This frame can be comprised from light weight metal, wood, plastic, fiberglass, or carbon fiber materials. The rear of the Acoustic Enhancement Balancer may also be supported by upper and lower frame braces that feature port holes to allow for air passage through the external non enclosed areas of the acoustic sound chambering system as illustrated in FIG. 5 component (B10), FIG. 6 component (C1), FIG. 6-a component (C4).

The internal acoustic sound filtration system of the Acoustic Enhancement Balancer is comprised of a series of sound chambers. The central acoustic sound chambering system is centered in the middle of this purification system and is a main series of sound dampening plates illustrated in FIG. 5 components (B3). These main plates are the largest of the systems dampening plates and serve as the central target for presented audio sound. These dampening plates act to reduce distortion by softening loud or aggressive audio waves and further aid to redirect the focus of sound waves to the right and left portions of the purification system.

The right and left portions of the Acoustic Enhancement Balancer feature additional smaller sound dampening plate arrangements FIG. 5 components (B4) that further aid in distributing the presented sound waves across the face of the filter. These dampening plates are broken into 4 separate independent sound chambers as shown in FIG. 5-a component (B11). That are separated and sectioned off by absorbency baffles shown in FIG. 5 components (B5), FIG. 5-a components (B8). The sound dampening plates are arranged evenly in row form with approximate spacing to balance sound wave flow; such, that their positions are spread across the filter for equal acoustic audio control and sound distribution as illustrated in diagrams for FIG. 5-5a. Concealing the acoustic sound dampening plates is a series of smaller independent cover filters FIG. 5-a component (B7). These cover filters exist to help control sound wave flow balance as to reduce potential audible noise contamination.

In between the rowed sound equalization/dampening plates are absorbency baffles shown in FIG. 5 components (B5), FIG. 5-a components (B8). These series of baffles primarily function in the reduction of distortion interference by absorbing harsh audible sound elements not directly captured into the sound chambers. The sound baffles are arranged to the right and left of the sound equalization plates and also assist as separators for each of the acoustic sound chambers. The positioning of these baffles also aids in the even distribution of sound waves that have entered the Acoustic Enhancement Balancer through the front and rear of the purification system in FIG. 5 & FIG. 5-a component (B9) the external rear filtration layer is shown in the rear of the baffles and sound chambers.

The entire acoustic sound purification system is closed in by a sound concealment barrier that encloses the top, bottom, and sides of the filter illustrated in FIG. 5-5a components (B6). This filter concealment/noise cancellation barrier eliminates noise contamination of outside sounds from entering the purification system from the top, bottom, or sides of the filter. The placement of the concealment barrier functions in aiding sound control by aiding air/sound flow to enter only from the front and rear of the filtering system so that sound waves can be properly purified through the internal purification system.

The base layer of the system is also part of the external filtration contact layer-internal filtration screen. It serves as the foundational layer for the purification system. This internal filtering screen covers the rear open area of the Acoustic Enhancement Balancer's frame. This base layers primary function is to filter potential sound contamination presented to the rear of the filter and secondarily protect the internal purification system from physical contamination of external elements such as dust and dirt particles. It is comprised of a thin acoustic material layer that does not constrict airflow so that sound can freely travel through the acoustic sound purification system.

### FIG. 1-1a

### Components A-L

A. Magnet
B. Detachable Magnetic Strip
C. Detachable Mount
D. Top acoustical foam sound reflection panel
E. Acoustical foam sound contact layer
F. Acoustical foam detachable panel
G. Side sound trap panel
H. Adjustable microphone stand slide on mount
I. Adjustable microphone adapter
J. Acoustical foam panel
K. Top mount removable acoustic foam panel
L. Acoustical foam sound damping barrier

### FIG. 2-2a

### Components M-S

M. Acoustical foam filter panel
N. Front mounted reflective sound shield
Q. Front sound shield mount
P. Microphone stand (mounting example)
Q. Acoustical foam filter panel
R. Adjustable base mount
S. Sound filtration Screen

### FIG. 3-3a

### Components T-A4

T. Filter screen
U. Acoustic foam filter panel
V. Microphone placement example
W. Front panel conjoining mount
X. Acoustical foam filter panel
Y. Magnetic removable mount
Z. Adjustable removable mount
A1. Rear sound deflector
A2. Insulated acoustic inner layer
A3. Rear sound trap barrier
A4. Adjustable mounting screws

### FIG. 4-4a

### Components A4-A11

A4. Upper sound dampening barrier
A5. Acoustic foam contact layer/filter front panel
A6. Lower sound dampening barrier
A7. Adjustable microphone mount
A8. Side sound barrier panels
A9. Ribbed acoustic foam filtration panel (sides)
A10. Pyramid acoustic foam filtration panel (center)
A11. Microphone mounting location

### FIG. 5-5a

### Components B1-B11

B1. Unit frame with ventilation port holes
B2. Mounting apparatus
B3. Central sound dampening plates
B4. Chambered Sound dampening plates
B5. Acoustic sound absorbency baffles
B6. External noise concealment barrier
B7. Sound chamber acoustic material filter layer (overlays dampening plates)
B8. Sound dampening absorbency baffles (sound chamber walls)
B9. Base layer acoustic filtration screen
B10. Portholes for air passage
B11. Sound plate chambers

### FIG. 6-6a

### Components C1-C5

C1. Upper and lower frame brace with portholes
C2. Perforated unit body frame
C3. Unit mount
C4. Acoustic Enhancement Balancer
C5. Microphone stand (mounting example)

### FIG. 7-7a

### Components D1-D8

D1. Adjustable microphone mount
D2. Sound trap panel
D3. Removable top mount filter panel
D4. Acoustic foam sound damping barrier
D5. Acoustical foam contact layer
D6. Adjustable rear unit slide on mount
D7. Rear sound deflector with portholes for open airflow
D8. Removable top panel mount quick release tabs

### FIG. 8-8a

### Components E1-E2

E1. Mesh filtration screen (External layer)
E2. Acoustic fiber material layer (Internal layer)

### FIG. 9

### Components F1

F1. Internal sound contact filtering layer

### FIG. 10

### Components G1-G4

G1. Acoustic Enhancement Balancer (shown in inverted overhead mounting position)
G2. Acoustic Enhancement Balancer mount
G3. Microphone boom extension arm (mounting example)
G4. Microphones stand (mounting example)

### FIG. 11

### Components H1-H3

H1. Acoustic Enhancement Balancer (shown in inverted overhead mounting position)
H2. Microphone boom arm (mounting example)
H3. Microphone stand (mounting example)

1. A sound enhancement audio capturing device that uses a systematic method to extract and purify sound presented into the system from multiple angles through an internal sound channeling system that arranges acoustic sound materials in a format that optimizes sound form processing, these materials are broken into multiple chambers that individually maintain a particular function to the overall sound processing of the system, these chambers are broken into a central main sound processing chamber and sub sound processing chambers placed adjacently to the main sound processing chamber, these chambers feature acoustic materials that are lined within these chambers that aid to dampen, soften, extract, and cleanse sounds resented into to the system, the level of acoustic materials used within each of these individual chambers will vary depending on the aspects of sound the chamber is intended to process, these chambers are protected by a screening layer that also maintains acoustic sound properties, this screening layer may be comprised of mesh, foam, cloth, plastic, metal, or fiber materials that allow unrestricted flow of air into the systems chambers, these screening layer portions may be met at both the front, rear, top, bottom, or sides of the system, this screening layer also provides additional levels of acoustic sound support and control of sound/air flow through the system by being positioned as a supportive guide layer for the sound chambers, the said acoustic materials, chambers and portions connect and join systematically to form an audio capturing sound purification system, this said system can be used in audio sound recording, instrument recording, audio broadcasting, live audio performances, and cinema sound recording, this completed system assists to reduce and eliminate audible noise contamination and sound form distorting elements that are present in room atmospheric conditions by means of channeling sounds directly inputted into this system through its internal sound processing chambers, sound processed through the systems series of chambers will result in the reduction or elimination of harmful and contaminating noise elements that are present in undesired recording locations and conditions; however, this said sound processing system will not significantly alter positive sound properties that are needed to produce vibrant, colorful, lively and energetic audio results that are desired in sound recording.

2. A Sound Enhancing System of claim 1 wherein the sound purification system is enclosed by a noise concealment barrier layer to improve efficiency of the audio capturing system by aiding sound/airflow into the designated internal sound chambers of the system for processing, this barrier may also provide a secondary function of protecting the internal system from physical and audio contaminants.

3. A Sound Enhancing System of claim 1 wherein the enclosed sound purification system consists of several independent sound chambers placed adjacently to the corresponding sound chambers each producing a separate role in the processing of sound throughout the system.

4. A Sound Enhancing System of claim 1 wherein the sound chamber system are several sound dampening plates made of acoustic materials arranged evenly or in row form with approximate spacing to balance and soften harsh or aggressive sound tones presented into the systems chambers.

5. A sound chamber system of claim 4 wherein the sound dampening plates may be covered by an acoustic material screening layer.

6. A Sound Enhancing System of claim 1 wherein the system's sound chambers consists a central chamber comprising of a larger sound dampening plate; which, is either connected as one assembly or split and aligned into several smaller dampening pieces.

7. A Sound Enhancing System of claim 1 wherein the sound chambers are separated by and sectioned off by sound absorbency baffles that may be used to separate the multiple sound processing chambers of the system.

8. A sound chamber of claim 4 wherein sound dampening plates may act to reduce sound distortion.

9. A Sound Enhancing System of claim 1 wherein additional acoustic sound support panels comprised of may be installed to the apparatus to increase function of the sound enhancement system by allowing a ceiling panel attachment and frontal sound screen attachment to be placed on the sound enhancement systems frame to offer 360 degrees of aided sound control, these additional components can be comprised of mesh, foam, cloth, plastic, metal, or fiber materials and are specifically designed to enhance the performance and resulting effect of the internal sound purification system, ideally in severe recording conditions.

10. A Sound Enhancing System of claim 9 wherein the additional acoustic panels can be permanent, adjustable, or removable.

11. A Sound Enhancing System of claim 1 wherein a microphone or other sound recording instrumentation can be used in conjunction with the system.

12. A Sound Enhancing System of claim 1 wherein the structure of the sound purification system is not restricted to a curved, bowed, dished, hexagonal, half circle, or domed shapes as the sound chambers described in claim 1 can also be structured to suit fitment in multiple acoustic sound enhancing designs and shapes that allow sound/air to flow evenly across the systems sound processing chambers.

13. A Sound Enhancing System of claim 1 wherein the completed sound enhancing system allows airflow and sound waves to enter and exit the internal sound purification system freely.

14. A Sound Enhancing System of claim 1 wherein the sound enhancing systems apparatus may contain portholes on the upper and lower ends to allow free travel of airflow and sound waves through the non enclosed sections of the sound purification system.

15. A Sound Enhancing System of claim 1 wherein the front of the systems apparatus may also features acoustic sound absorbent materials on the upper and lower portions of the frame to capture sound not presented directly into the Sound purification system.

16. A Sound Enhancing System of claim 1 wherein the system is also non restrictive to multiple mounting setups and arrangements for adaptation in various recording applications and environments.

17. A Sound Enhancing System of claim 1 wherein the screening layer is comprised of mesh, foam, cloth, plastic, metal, or fiber materials that promote acoustic support and sound guidance of sound across the sound enhancing system.

18. A Sound Enhancing System of claim 1 wherein the external sound contact layer is a non airflow restrictive material that filters potential sound contamination presented to the rear of acoustic sound purification system.

19. A Sound Enhancing System of claim 1 wherein the screening layers also protects the internal purification system from physical contamination of external elements such as dust and dirt particles.

20. The structure of the sound purification system of claim 12 wherein the structure may be comprised from metal, wood, plastic, fiberglass, or carbon fiber materials.
